(19) United States
(12) Patent Application Publication
(10) Pub. No.: US 2026/0153074 A1
(43) Pub. Date: Jun. 4, 2026

(54) AN APPARATUS FOR CONTROLLING FLUID FLOW TO TURBINES

(71) Applicant: NEWCO142 LIMITED, Durham (GB)

(72) Inventor: Avinash SHANKER, Durham (GB)

(73) Assignee: NEWCO142 LIMITED, Durham (GB)

(21) Appl. No.: 19/510,057

(22) PCT Filed: Aug. 9, 2024
(86) PCT No.: PCT/EP2024/072574

§ 371 Date: Feb. 10, 2026

(30) Foreign Application Priority Data
Aug. 10, 2023 (GB) 231226.0
Dec. 15, 2023 (GB) 2319220.6

(51) Int. Cl. F03D 3/04; F03D 3/00

(52) U.S. Cl. CPC F03D 3/0409; F03D 3/009; F03D 3/011

(57) ABSTRACT

The invention provides an apparatus for introducing skew to a fluid flow directed on to one or more vertical axis turbines, the apparatus comprising a support structure having mounted thereon a plurality of vertically spaced aerofoils arranged to surround the one or more vertical axis turbines, the vertical spacings being selected and the aerofoils being profiled and arranged at an angle such that fluid flow between the aerofoils is skewed before it is incident upon the one or more vertical axis turbine.

The present invention relates to an apparatus for controlling fluid flow to turbines and more particularly to a ducting system to direct fluids and/or gases to certain types of turbine in such a way as to improve the efficiency of the turbines.

### BACKGROUND OF THE INVENTION

Wind and water turbines can be classified into two main types, namely those that rotate about a horizontal axis (as with conventional windmills and water mills), and those that rotate about a vertical axis.

A variety of different configurations of vertical axis wind turbines are known and two widely investigated types are wind turbines having Darrieus or Savonius configurations.

Savonius-type turbines comprise an array of hollow vanes or scoops (typically two or three) mounted for rotation about a vertical axis; see U.S. Pat. Nos. 1,697,574 and 1,766,765. Darrieus-type wind turbines, named after their inventor Georges Darrieus, comprise a number of curved aerofoil blades mounted on a rotating shaft or platform, see for example U.S. Pat. No. 1,835,018. For a review of Darrieus-type wind turbines, see Tjiu et al., “Darrieus vertical axis wind turbine for power generation I: Assessment of Darrieus VAWT configurations”, Renewable Energy, 75(2015 ), 50-67, and Kuam et al., “A Review on the Evolution of Darrieus Vertical Axis Wind Turbine: Small Wind Turbines”, Journal of Power and Energy Engineering, 2019, 7, 27-44.

The aerofoil blades of wind turbines may have a fixed pitch or a variable pitch. Variable-pitch vertical-axis wind turbines are known variously as cyclorotor turbines or cycloturbines and examples of such turbines are the vertical axis wind turbines described in P. W. Carlin et al., Wind Energ., 2003; 6:129-159 and references cited therein, the contents of each of which are incorporated herein by reference.

Various proposals have been made for improving the efficiency of vertical axis wind turbines.

WO 2006/066310 describes a wind turbine apparatus having a lower wind collection chamber which discharges collected air upwardly through the turbine rotor. In the apparatus, the rotor is preferably a horizontal-axis type wind turbine rotor mounted vertically.

FR 2986282 discloses a vertical axis wind turbine apparatus in which the turbine rotors are surrounded by an enclosure having openings between curved deflector plates through which wind is directed upwardly onto the blades of the turbine rotor. The air flow through the rotor blades is predominantly in an axial direction (as with a horizontal axis wind turbine) rather than predominantly transversely relative to the axis of rotation of the rotor.

EP 4160002 discloses a wind turbine apparatus comprising a vertical axis turbine contained within a shroud formed from a plurality of spaced apart angled/curved blades or aerofoils which are shaped to direct airflow in an upwards direction and through the rotor.

EP 3564525 discloses a wind turbine apparatus comprising a wind deflector which channels air vertically upwards and through a variable pitch rotor.

U.S. Pat No. 4,309,146 describes a wind turbine apparatus in which wind is amplified by passing it through a “first rotation chamber” to rotate the air before directing it upwardly through a turbine.

U.S. Pat No. 8,546,971 describes an apparatus for collecting wind and directing it upwardly and through a wind turbine.

The proposals discussed above all relate to wind turbine arrangements in which wind is collected and then channelled upwardly through a turbine rotor. The turbines are thus acting essentially as horizontal axis wind turbines turned through 90° rather than as true vertical axis wind turbines.

US 2009/00791998 discloses a protective cover for surrounding a vertical axis wind turbine. The cover does not appear to serve any useful purpose in enhancing the effect of wind on the turbine.

KR 20120085452 describes a vertical axis wind turbine apparatus for mounting on a wall. The apparatus has a series of movable guide walls for controlling wind access to the turbine.

GR 1008055 discloses a vertical axis wind turbine apparatus comprising a static enclosure provided with “cones” and fins surrounding a plurality of stacked independently rotating impellers.

In the apparatus of GR 1008055, the driving forces for the rotation of the impellers are stated to be (a) the force of air passing into the turbine from the side, which air is stated be compressed by the “cones” and fins” so that there is an increase in air pressure incident upon the blades of the turbine impeller (4); and (b) the force of the air movement created by one impeller which assists rotation of a neighbouring impeller in the stack. It is disclosed that the impellers are configured to direct air downwards sol that the uppermost impeller will assist the rotation of the impeller below it, and the next impeller down will in turn assist the rotation of the impeller below it, and so on. Only the uppermost impeller does not benefit from the assistance provided by force (b).

Mertens et al. (“Performance of an H-Darrieus in the Skewed Flow on a Roof”, Journal of Solar Energy Engineering, November 2003, Vol. 125, 433-439)) have shown through Computational Fluid Dynamics (CFD) calculations that an H-Darrieus wind turbine can produce an increased power output when the flow of air incident upon the blades of the turbine has been skewed as it flows over the windward edge of a roof on which the turbine is mounted.

Mertens et al. observed that the skew angle of air passing through a turbine mounted on a roof will vary according to, inter alia, the height of the building, with skew angles being greater on the roofs of taller buildings and smaller on roofs of shorter buildings. They were able to demonstrate both by calculation and by measurements obtained in wind tunnel experiments that the performance coefficient (C_{P}) of the turbine was a function of the skew angle (γ).

In principle, it should be possible to tilt or heel a vertical axis wind turbine so that airflow is incident on the blades of the turbine at the optimum skew angle. However, whilst heeling a turbine to skew fluid flow in an offshore or river environment could be a matter of tethering the structure to the bed of the water body and allowing wind or water movement to produce a heeling effect on a floating spar buoy structure-in much the same way as for example a sailboat will heel in wind-obtaining this effect on land is rather more challenging. For example, vertical axis wind turbines could theoretically be suspended on land from a horizontally supported structure (e.g. a structure having a football goal post profile) and allowed to move freely in the wind, naturally heeling at an angle to the wind as wind contacts an appropriately weighted free-moving suspended turbine. Alternatively, the entire turbine structure could be set upon its foundations at a fixed desired angle (which would require knowledge of the optimal angle in view of the local conditions), or on a gimbal mount to allow more dynamic heeling movement to skew the flow through the turbine. The technical issues associated with such configurations will readily be understood by the skilled person and range from the dangers and issues emanating from a solid, rotating object moving freely in variable wind suspended on a tether, to the structural stresses placed upon either a fixed structure held at an angle significantly away from the vertical, or able to move dynamically away from the vertical plane via a mount affixed to the ground. Even if such structures were deemed practical, the engineering and control of such systems would be expected to present significant challenges.

### The Invention

It is an object of the present invention to provide an apparatus which mitigates or obviates at least one of the disadvantages of known or tested methods and devices.

It is also an object of the invention to provide an apparatus that is lightweight, robust and, where control is desired, easy to control, allowing the skew of flow required at a wide range of flow rates, using a number of stacked aerofoils or ducts of a specified size and spacing acting together under common control mechanisms.

It is a further object of the invention to provide an apparatus to dynamically prevent, in large part, wind or fluid from entering into the turbine when prevailing conditions are unsuitable, such as during the occurrence of very high velocity wind or water flows, or where solid material is entrained in the flow.

It is another object of the invention to reduce or eliminate the dangers to wildlife often inherent in the production of energy from wind or water when employing certain turbine designs; in particular but not limited to bird or fish strikes.

An additional object of the invention is to obscure the movement of turbine blades from view, eliminating shadow flicker, environmental impact and visual degradation of land-and seascapes.

The present invention makes use of a plurality of aerofoils each linked to one another, and optionally in turn to a control mechanism (e.g. cable or rod-based control mechanism) capable of moving all aerofoils in tight coordination with one another, wherein each aerofoil directs flow toward an adjacent aerofoil in order to deliver minimum resistance to or obstruction of the flow whilst also introducing significant skew to said flow, and thereby also minimising the energy lost in obtaining sufficient skew prior to the air or water contacting the turbine(s).

The aerofoils may be arranged in a circular pattern around the turbine(s) and in this way direct and control flow both into and out of the turbine(s).

In the apparatus of the present invention, the aerofoils at least partially surround the wind turbine. The arrangement is therefore different from the known Darwin wind turbine where a wind collector enclosure provided with a plurality of hinged flaps is positioned beneath a wind turbine and wind collected by the enclosure is directed upwards through the turbine.

Accordingly, in a first aspect (Embodiment 1), the invention provides an apparatus for introducing skew to a fluid flow directed on to one or more vertical axis turbines, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow between the aerofoils is skewed before it is incident upon the one or more vertical axis turbines.

The vertical spacings are typically selected and the aerofoils are typically profiled and arranged at an angle such that fluid flow is skewed as it flows between the aerofoils and remains skewed as it is incident upon at least one of the one or more vertical axis turbines.

In another aspect (Embodiment 2), the invention provides an apparatus for introducing skew to a fluid flow directed on to a vertical axis turbine, the apparatus comprising a support structure having mounted thereon a plurality of vertically spaced aerofoils arranged to partially or completely surround the vertical axis turbine, the vertical spacings being selected and the aerofoils being profiled and arranged at an angle such that fluid flow is skewed as it flows between the aerofoils and remains skewed as it is incident upon the vertical axis turbine.

In another aspect (Embodiment 3), the invention provides a vertical axis turbine assembly comprising a vertical axis turbine and an apparatus for introducing skew to a fluid flow directed towards the vertical axis turbine, the apparatus comprising a support structure having mounted thereon a plurality of vertically spaced aerofoils arranged to partially or completely surround the vertical axis turbine, the vertical spacings being selected and the aerofoils being profiled and arranged at an angle such that fluid flow between the aerofoils is skewed as it flows between the aerofoils and remains skewed as it is incident upon the vertical axis turbine.

In another aspect (Embodiment 4, the invention provides an apparatus for introducing skew to a fluid flow directed on to one or more vertical axis turbines, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow is skewed as it flows between the aerofoils and remains skewed as it is incident upon the one or more vertical axis turbines.

In another aspect (Embodiment 5), the invention provides a vertical axis turbine assembly comprising one or more vertical axis turbines and an apparatus for introducing skew to a fluid flow directed towards the one or more vertical axis turbines, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow between the aerofoils is skewed as it flows between the aerofoils and remains skewed as it is incident upon the one or more vertical axis turbines.

The term “vertical axis turbine” as used herein refers to a turbine driven by fluid flow onto the turbine from a predominantly transverse direction relative to the axis of rotation of the turbine. The vertical axis turbines and enclosures of the invention are thus distinguished from arrangements such as those disclosed in WO 2006/066310, FR 2986282, EP 4160002,EP 3564525, U.S. Pat Nos. 4,309,146 and 8,546,971 where enclosures around a wind turbine divert wind in a generally upwards direction so that the airflow through the blades of the turbine is substantially aligned with the axis of the wind turbine rather than being predominantly transverse with respect to the wind turbine axis.

The term “fluid” as used herein, unless the context indicates otherwise, refers generally to gases and liquids. Whereas the invention is illustrated herein primarily by reference to wind turbines, it will be appreciated that apparatuses for use with, or comprising, water turbines or turbines driven by other liquids and gases are also within the ambit of the invention.

In each of the foregoing five aspects of the invention (Embodiments 1 to 5), the plurality of vertically spaced aerofoils is arranged to partially or completely surround the vertical axis turbine (or one or more vertical axis turbines). The plurality of vertically spaced aerofoils can be arranged to partially or completely surround a single vertical axis turbine, or a group of more than one vertical axis turbine.

Further embodiments of the invention are embodiments 6 to 23 below.

Embodiment 6: An apparatus or vertical axis turbine assembly according to any one of Embodiments 1 to 5 wherein the aerofoils are arranged to completely surround the vertical axis turbine (or one or more vertical axis turbines).

Embodiment 7: An apparatus or vertical axis turbine assembly according to any one of Embodiments 1 to 5 wherein the aerofoils are arranged to partially surround the vertical axis turbine (or one or more vertical axis turbines).

Embodiment 8: An apparatus or vertical axis turbine assembly according to any one of Embodiments 1 to 6 wherein the plurality of vertically spaced aerofoils is arranged to completely surround a single vertical axis turbine.

Embodiment 9: An apparatus or vertical axis turbine assembly according to any one of Embodiments 1 to 5 and 7 wherein the plurality of vertically spaced aerofoils is arranged to partially surround a single vertical axis turbine.

Embodiment 10: An apparatus or vertical axis turbine assembly according to any one of Embodiments 1 to 6 wherein the plurality of vertically spaced aerofoils is arranged to completely surround a group of more than one vertical axis turbine.

Embodiment 11: An apparatus or vertical axis turbine assembly according to any one of Embodiments 1 to 5 and 7 wherein the plurality of vertically spaced aerofoils is arranged to partially surround a group of more than one vertical axis turbine.

Embodiment 12: An apparatus or vertical axis turbine assembly according to any one of Embodiments 1 to 11, as appropriate, wherein the one or more vertical axis turbines consist of from one to ten vertical axis turbines.

Embodiment 13: An apparatus or vertical axis turbine assembly according to Embodiment 12 wherein the apparatus is configured for use with only a single vertical axis turbine.

Embodiment 14: An apparatus or vertical axis turbine assembly according to Embodiment 12 wherein the apparatus is configured for use with two vertical axis turbines.

Embodiment 15: An apparatus or vertical axis turbine assembly according to Embodiment 12 wherein the apparatus is configured for use with three vertical axis turbines.

Embodiment 16: An apparatus or vertical axis turbine assembly according to Embodiment 12 wherein the apparatus is configured for use with four vertical axis turbines.

Embodiment 17: An apparatus or vertical axis turbine assembly according to Embodiment 12 wherein the apparatus is configured for use with five vertical axis turbines.

Embodiment 18: An apparatus or vertical axis turbine assembly according to Embodiment 12 wherein the apparatus is configured for use with six vertical axis turbines.

Embodiment 19: An apparatus or vertical axis turbine assembly according to Embodiment 12 wherein the apparatus is configured for use with seven vertical axis turbines.

Embodiment 20: An apparatus or vertical axis turbine assembly according to Embodiment 12 wherein the apparatus is configured for use with eight vertical axis turbines.

Embodiment 21: An apparatus or vertical axis turbine assembly according to Embodiment 12 wherein the apparatus is configured for use with nine vertical axis turbines.

Embodiment 22: An apparatus or vertical axis turbine assembly according to Embodiment 12 wherein the apparatus is configured for use with ten vertical axis turbines.

Embodiment 23: An apparatus or vertical axis turbine assembly according to any one of Embodiments 1 to 22 wherein, when there is more than one vertical axis turbine as hereinbefore defined, or when the apparatus is configured for use with more than one vertical axis turbine as hereinbefore defined, each of the vertical axis turbines (i.e. the rotor thereof) is mounted on its own shaft.

The support structure may be static, i.e. non-rotatable, or it may be rotatable about a substantially vertical axis. When it is rotatable, the apparatus preferably comprises a control mechanism that enables the support structure to be rotated to a desired extent. The control mechanism may comprise a motor, typically an electric motor for bringing about rotation. Accordingly, in further embodiments, the invention provides:

Embodiment 24: An apparatus or vertical axis turbine assembly according to any one of Embodiments 1 to 23 wherein the support structure is static, i.e. non-rotatable.

Embodiment 25: An apparatus or vertical axis turbine assembly according to any one of Embodiments 1 to 23 wherein the support structure is rotatable about a substantially vertical axis.

Embodiment 26: An apparatus or vertical axis turbine assembly according to Embodiment 25 wherein the apparatus comprises a control mechanism that enables the support structure to be rotated to a desired extent.

Embodiment 27: An apparatus or vertical axis turbine assembly according to Embodiment 26 wherein the control mechanism comprises a motor, typically an electric motor, for bringing about rotation.

The aerofoils may be mounted on the support structure so as to fully or partly surround the one or more vertical axis turbines. Where the aerofoils only partly surround the vertical axis turbine(s), one or more non-aerofoil wall structures may be interposed between regions of aerofoils around a perimeter (e.g. circumference) of the apparatus. The non-aerofoil wall structures are typically formed so as to prevent or restrict the passage of fluids therethrough and may extend from top to bottom of the support structure. When the support structure is rotatable, it may be rotated so as to bring either an aerofoil-containing region or a non-aerofoil wall structure into position to face the fluid flow depending on whether it is desired to expose the vertical axis turbine(s) to the fluid flow, or fully or partially block the flow of fluid onto the turbine(s).

Accordingly, a further embodiment (Embodiment 28) provides an apparatus or vertical axis turbine assembly according to any one of the preceding Embodiments wherein the aerofoils only partly surround the vertical axis turbine(s), and one or more non-aerofoil wall structures are interposed between regions of aerofoils around a perimeter (e.g. circumference) of the apparatus.

In another embodiment (Embodiment 29), the invention provides an apparatus for introducing skew to a fluid flow directed on to a vertical axis turbine, the apparatus comprising a support structure having mounted thereon a plurality of vertically spaced aerofoils arranged to surround the vertical axis turbine, the vertical spacings being selected and the aerofoils being profiled and arranged at an angle such that fluid flow between the aerofoils is skewed before it is incident upon the vertical axis turbine.

In another aspect (Embodiment 30), the invention provides an apparatus for introducing skew to a fluid flow directed on to a vertical axis turbine, the apparatus comprising a support structure having mounted thereon a plurality of vertically spaced aerofoils arranged to surround the vertical axis turbine, the vertical spacings being selected and the aerofoils being profiled and arranged at an angle such that fluid flow is skewed as it flows between the aerofoils and remains skewed as it is incident upon the vertical axis turbine.

In another aspect (Embodiment 31), the invention provides a vertical axis turbine assembly comprising a vertical axis turbine and an apparatus for introducing skew to a fluid flow directed towards the vertical axis turbine, the apparatus comprising a support structure having mounted thereon a plurality of vertically spaced aerofoils arranged to surround the vertical axis turbine, the vertical spacings being selected and the aerofoils being profiled and arranged at an angle such that fluid flow between the aerofoils is skewed as it flows between the aerofoils and remains skewed as it is incident upon the vertical axis turbine.

In another aspect (Embodiment 32), the invention provides a method of increasing the efficiency of one or more vertical axis turbines, which method comprises surrounding the vertical axis turbine(s) with a support structure having mounted thereon a plurality of vertically spaced aerofoils, the vertical spacings being selected and the aerofoils being profiled and arranged at an angle such that fluid flow between the aerofoils is skewed before it is incident upon the vertical axis turbine(s).

According to the invention, the flow of fluid to a vertical axis turbine is skewed before it reaches the blades of the turbine, and the spacing and profile of the aerofoils are selected so as to impart an angle of skew (the skew angle) which enhances the performance of the turbine (for example as represented by the performance coefficient (C_{P}) of the turbine).

Thus, whereas Mertens et al. (idem) describe situations in which the skew angle of an airflow is determined by the height and other characteristics of a building upon which a wind turbine is mounted, the present invention provides a means of imparting a desired degree of skew to an airflow (and other fluid flow) which is independent of the topography of any structures on which the turbine is mounted or neighbouring structures.

Thus, the invention provides a means of exposing a vertical axis turbine to a skewed fluid flow equivalent or similar to the skewed fluid flow to which the turbine blades would be exposed if the turbine were tilted or heeled, but without the disadvantages and complexities that would be involved in providing a tilting turbine.

According to the invention, each vertical axis turbine is mounted on a fixed non-tilting substantially vertical support and a ducting system is provided which surrounds the vertical axis turbine(s) and provides the desired skewed flow of fluid onto the blades of the turbine(s).

The vertical support may be rotatable on a base so as to be capable of presenting different faces to the fluid flow, or it may be non-rotating.

The embodiments, preferences and examples set out below apply to each of the aspects of the invention as set out above, unless the context indicates otherwise.

In this application, references to distances and lengths may be given in metres (abbreviated in some instances to “m”).

In some instances herein, the term “array” is used to refer to the “plurality of aerofoils”.

The flow of fluid onto the blades of the turbine(s) is skewed such that, even after skewing, the flow is still directed on to the blades of the turbine from a direction which is predominantly transverse relative to the axis of rotation of the turbine.

Preferably, the fluid flow is subjected to skew angles of up to ±30°, for example from +10° to +30° or −10° to −30°. In one embodiment, the fluid flow is subjected to skew angles ranging from +25° to +29°. In another embodiment, the fluid flow is subjected to skew angles ranging from −25° to −29°.

Accordingly, the fluid flow having passed between the aerofoils, is incident upon the turbine blades at an angle of greater than 0° and up to +30°, for example from +10° to +30° or −10 ° to −30° relative to horizontal. In one embodiment, the fluid flow is incident upon the turbine blades at an angle of from +25° to +29°. In another embodiment, the fluid flow is incident upon the turbine blades at an angle of-25° to −29° relative to horizontal.

In a further embodiment, the fluid flow having passed between the aerofoils, is incident upon the turbine blades at an angle of from 60° to 85° relative to the axis of rotation of the turbine, for example from 60° to 80° relative to the axis of rotation of the turbine. In one embodiment, the fluid flow is incident upon the turbine blades at an angle of from 61° to 69° relative to the axis of rotation of the turbine.

### Thus, in Further Embodiments 33 to 38, the Invention Provides:

Embodiment 33: An apparatus or vertical axis turbine assembly according to any one of Embodiments 1 to 32 wherein the fluid flow is subjected to skew angles of up to ±30°, for example from +10° to +30° or −10° to −30°.

Embodiment 34: An apparatus according to Embodiment 33 wherein the fluid flow is subjected to (i) skew angles ranging from +25° to +29°; or (ii) skew angles ranging from −25° to −29°.

Embodiment 35: An apparatus or vertical axis turbine assembly according to any one of Embodiments 1 to 32 which is configured such that fluid flow having passed between the aerofoils is incident upon the turbine blades at an angle of greater than 0° and up to ±30°, for example from +10° to +30° or −10° to −30°relative to horizontal.

Embodiment 36: An apparatus or vertical axis turbine assembly according to Embodiment 35 wherein the fluid flow (a) is incident upon the turbine blades at an angle of from +25° to +29°; or (b) is incident upon the turbine blades at an angle of −25° to −29°, relative to horizontal.

Embodiment 37: An apparatus or vertical axis turbine assembly according to any one of Embodiments 1 to 32 which is configured such that fluid flow having passed between the aerofoils is incident upon the turbine blades at an angle of from 60° to 85° relative to the axis of rotation of the turbine, for example from 60° to 80° relative to the axis of rotation of the turbine.

Embodiment 38: An apparatus or vertical axis turbine assembly according to Embodiment 37 which is configured such that the fluid flow is incident upon the turbine blades at an angle of from 61° to 69° relative to the axis of rotation of the turbine.

The vertical axis turbine(s) can be a wind turbine, or it may be any other form of turbine (such as a water turbine) where the motive power for the turbine is provided by a fluid flow. Accordingly, in further embodiments (Embodiments 39 to 47), the invention provides:

Embodiment 39: An apparatus or vertical axis turbine assembly according to any one of Embodiments 1 to 38 wherein the vertical axis turbine is a wind turbine.

Embodiment 40: An apparatus or vertical axis turbine assembly according to Embodiment 39 wherein the vertical axis wind turbine is a wind turbine having a Darrieus or Savonius configuration.

Embodiment 41: An apparatus or vertical axis turbine assembly according to Embodiment 40 wherein the wind turbine has a Darrieus configuration.

Embodiment 42: An apparatus or vertical axis turbine assembly according to Embodiment 40 wherein the wind turbine has a Savonius configuration.

Embodiment 43: An apparatus or vertical axis turbine assembly according to Embodiment 41 wherein the vertical axis turbine is a variable-pitch vertical-axis wind turbine, known variously as a cyclorotor turbine or cycloturbine.

Examples of the turbines of Embodiment 43 are the vertical axis wind turbines described in P. W. Carlin et al., Wind Energ., 2003; 6:129-159 and references cited therein, the contents of each of which are incorporated herein by reference.

Embodiment 44: An apparatus or vertical axis turbine assembly according to Embodiment 39 wherein the wind turbine is a vertical axis wind turbine selected from:
(i) a turbine comprising a plurality of straight or curved elongate blades linked by one or more lateral support members to a common rotating shaft or hub; and
(ii) a turbine comprising a plurality of curved elongate blades linked at upper and lower ends thereof to a common rotating shaft.

In wind turbines of type (i) and type (ii) of Embodiment 44, the blades are elongate in a predominantly axial direction, i.e. from top to bottom or vice versa. By “predominantly axial” is meant that the axial dimension of the elongate blades (the distances along the axis over which the blades extend) is greater than their radial dimension (i.e. the width of the blades in a radial direction).

Embodiment 45: An apparatus or vertical axis turbine assembly according to Embodiment 44 wherein the turbine is of type (i) and comprises a plurality of substantially straight elongate blades each linked by two or more lateral support members to a common rotating shaft, wherein the substantially straight elongate blades have an alignment substantially parallel to the axis of rotation (i.e. the turbine is of an H-rotor configuration).

Embodiment 46: An apparatus or vertical axis turbine assembly according to Embodiment 44 wherein the turbine is of type (i) and comprises a plurality of curved elongate blades each linked by two or more lateral support members to a common rotating shaft, wherein the curved elongate blades have an alignment which is substantially helical about the axis of rotation.

Embodiment 47: An apparatus or vertical axis turbine assembly according to Embodiment 44 wherein the turbine is of type (i) and comprises a plurality of substantially straight elongate blades each linked by two or more lateral support members to a common rotating shaft, wherein the substantially straight elongate blades are each individually fully or partially rotatable about a subsidiary axis which is substantially parallel to the axis of rotation (“main axis”) of the turbine (e.g. the turbine has a cyclorotor configuration).

Where there is more than one vertical axis turbine, they may all be of the same type and configuration, or there may be a mix of vertical axis turbines of different types and configurations.

In a further embodiment (Embodiment 48) of the invention as defined in any one of Embodiments 1 to 38, the vertical axis turbine is a water turbine. Examples of water turbines are turbines located in rivers, or in tidal estuaries, or in offshore locations where there is a current which can provide the motive power for the turbine.

The apparatus comprises a support structure having mounted thereon a plurality of vertically spaced aerofoils arranged to surround the vertical axis turbine(s). Each of the vertically spaced aerofoils may take the form of a single aerofoil which surrounds the turbine(s). Alternatively, each of the vertically spaced aerofoils may comprise a plurality of aerofoil segments linked together so as to surround the turbine(s).

In another embodiment, the aerofoils or aerofoil segments may be arranged so as to only partially surround the vertical axis turbine(s), with horizontal spacings between aerofoils or aerofoil segments being filled by one or more non-aerofoil wall structures (e.g. panels) so that the aerofoils or aerofoil segments and non-aerofoil wall structures together surround the vertical axis turbine(s).

In one embodiment, the aerofoils (or plurality of linked aerofoil segments) are elliptical (e.g., circular) or annular in plan (i.e. when viewed from above).

In another embodiment, the aerofoils (or plurality of linked aerofoil segments) are polygonal (preferably regular polygonal) in plan.

For example, the aerofoils (or plurality of linked aerofoil segments) may be square, pentagonal, hexagonal, heptagonal, octagonal, nonagonal, decagonal, undecagonal or dodecagonal in plan.

In a further embodiment, the aerofoils (or plurality of linked aerofoil segments) are oval in plan.

In one particular embodiment, the support structure has mounted thereon a plurality of vertically spaced aerofoils arranged to surround the vertical axis turbine(s), each of the aerofoils being elliptical (e.g., circular) in plan.

In another particular embodiment, the support structure has mounted thereon a plurality of vertically spaced aerofoils arranged to surround the vertical axis turbine(s), each of the aerofoils comprising a plurality of straight aerofoil segments linked together in a polygonal array so as to surround the turbine(s).

Each aerofoil has an outer leading edge and an inner trailing edge. In a general embodiment (Embodiment 49) of the invention as defined in any one of Embodiments 1 to 48, the vertical distances (d1) between the leading edges of adjacent aerofoils and the vertical distances (d2) between the trailing edges of the said adjacent aerofoils are substantially the same, or differ by no more than 10%, preferably by no more than 5%.

In one embodiment (Embodiment 50) of the invention as defined in any one of Embodiments 1 to 49, the aerofoils are static, i.e., they have a fixed angle and vertical spacing. In another embodiment (Embodiment 51) of the invention as defined in any one of Embodiments 1 to 49, the aerofoils are adjustable in angle and/or vertical spacings.

When the aerofoils are static, the vertical spacings between the aerofoils and the angles of the aerofoils may be preselected to provide skew angles that are optimised for the location in which the vertical axis turbine is to be used.

As an alternative to static aerofoils, the aerofoils may be adjustable in angle and/or vertical spacings so that they can provide optimal skew in variable environmental conditions, for example varying wind speeds and directions.

Where the aerofoils are adjustable, it is preferred that a control mechanism is linked to each aerofoil to allow their coordinated movement together.

In one embodiment, the control mechanism is configured so that all of the aerofoils move together in locked coordination.

In another embodiment, the control mechanism is configured so that groups (pluralities) of aerofoils can be moved independently, each member of a group being movable in locked coordination with the other members of the group.

In a further embodiment, the control mechanism is configured so that individual aerofoils can be moved independently.

The control mechanism may comprise one or more articulatable support cables or rods attached to or passing through the aerofoils or other means of aerofoil array support, and at least one additional rod or cable capable of adjusting the angle of attack of the aerofoil.

Where adjacent aerofoils are linked by or attached to support cables of rods, they are typically arranged for movement in locked coordination.

An electronic controller may advantageously be operatively linked via the control mechanism to the plurality of aerofoils (the aerofoil array) which is programmed or programmable to control the direction and/or rate of movement of the aerofoils.

The electronic controller may be operatively linked to one or more sensors for measuring wind speed and direction (or the direction of flow and speed of flow of alternative fluids such as water), the controller being programmed or programmable to control the movement of the aerofoils in response to signals received from the sensors.

The aerofoils may be adjustable in angle (tilted) by virtue of being pivotably mounted. For example, the aerofoils may be mounted on pivots (e.g. pivot rods) which are linked to control cables, rods, motor drives or other mechanisms for rotating the pivot rods.

Alternatively, the aerofoils may be connected by rods or cables to adjacent aerofoils such that movement of the rods or cables results in coordinated titling of the connected aerofoils.

The rods or cables may, for example be attached to the leading edges and trailing edges of the aerofoils.

In order to prevent distorting or buckling of the aerofoils as they are adjusted in angle, the aerofoils may be provided with a degree of flexibility so that their radially inner and radially outer edges can lengthen or shorten as necessary as the aerofoils are tilted.

Aerofoils may be formed from a flexible textile material stretched over an aerofoil profile and/or tube framework.

In one embodiment, the aerofoils each comprise a support framework formed from tubes, the framework being covered by a suitably durable fabric such as a woven textile or a sheet material formed from a suitable polymeric material (e.g. polyurethane or polyurethane-coated fabric). In this embodiment, the tubes can be linked together in a telescopic manner to allow lengthening or shortening of the radially inner and radially outer edges of the aerofoils as they are tilted. Alternatively, or additionally, the support framework may contain or more compression/expansion joints to allow shortening or lengthening of the radially inner and radially outer edges of the aerofoils as they are tilted.

Instead of, or in addition to, the aerofoils having radially inner and outer edges that are capable of shortening or lengthening, each aerosol may comprise a plurality of aerofoil segments linked together so as to surround the turbine. For example, each aerofoil may comprise from two to ten aerofoil segments (more usually from three to eight, and preferably four to six segments) arranged to form a perimeter (e.g. a circumference) which surrounds the turbine. In order to prevent buckling of the aerofoil segments as they are tilted, the aerofoil segments, whilst operatively linked, may be perimetrically spaced apart (i.e. spaced apart in a horizontal direction) so that neighbouring aerofoil segments do not come into contact to an extent that they would impact against each other and cause mutual distortion as they are tilted.

In addition to being tiltable, at least some, and typically all of the aerofoils may also be moveable in a vertical direction (up or down) so that the vertical spacings between the aerofoils can be adjusted. The aerofoils can therefore be mounted on cables, slides or other mechanisms that allow them to move in a coordinated manner in a vertical plane. The mechanisms for varying the vertical spacings between aerofoils are preferably operatively linked to an electronic controller as defined above.

In an alternative embodiment (Embodiment 52) of the invention as defined in any one of Embodiments 1 to 50, the aerofoils have a fixed configuration (i.e. they are not adjustable with regard to angles or spacings) but the plurality of vertically spaced aerofoils are divided into two or more regions wherein the aerofoils in one region impart different skew characteristics to the fluid flow than the aerofoils in another region. In this embodiment, the support structure can be rotatable so that different regions of the plurality of aerofoils can be arranged to face the fluid flow. In this embodiment, the aerofoils in a given region can be set up to provide optimal fluid flow for particular ambient fluid flow conditions. The entire structure can therefore be rotated to present to the fluid flow the region of aerofoils judged to be most appropriate for the ambient fluid flow conditions.

Accordingly, in one preferred embodiment (Embodiment 53) of the invention as defined in any one of Embodiments 1 to 50, there is provided an apparatus for introducing skew to a fluid flow directed on to one or more vertical axis turbines, the apparatus comprising a support structure having mounted thereon a plurality of vertically spaced aerofoils arranged to surround the vertical axis turbine(s), the vertical spacings being selected and the aerofoils being profiled and arranged at an angle such that fluid flow between the aerofoils is skewed before it is incident upon the vertical axis turbine(s); the plurality of vertically spaced aerofoils being divided into two or more regions wherein the aerofoils in one region impart different skew characteristics to the fluid flow than the aerofoils in another region; and wherein the support structure is be rotatable about a substantially vertical axis so that different regions of the plurality of aerofoils can be presented to face the fluid flow.

In this embodiment, the support structure can be in the form of a tower comprising a plurality of upwardly extending frame members and an array of stacked rows of the aerofoils mounted on the support structure; each stacked row of aerofoils being configured for surrounding one or more vertical axis turbines; and each said row comprising a plurality of aerofoil segments; wherein each aerofoil segment is connected between a pair of adjacent upwardly extending frame members.

The plurality of upwardly extending frame members can be arranged in a circular, elliptical, oval or polygonal pattern so as to be capable of surrounding a vertical axis turbine(s).

In one embodiment (Embodiment 54), the upwardly extending frame members are arranged in a circular pattern.

The tower comprises at least three upwardly extending frame members, and typically there will be from three to twenty such frame members.

In one embodiment (Embodiment 55), there are eight to twelve upwardly extending frame members and, in one particular embodiment (Embodiment 56), there are ten such frame members.

The aerofoil segments connected between a given pair of adjacent upwardly extending frame members together constitute a segment (a “stack segment”) of the array of stacked rows of the aerofoils. The aerofoil segments in one stack segment may be configured to impart different skew characteristics to a fluid flow than the aerofoil segments in another stack segment. Thus, one or more stack segments may constitute a region as hereinbefore defined.

In this embodiment, the tower may be rotatable about a substantially vertical axis. This enables different stack segments to be brought into an orientation facing the fluid flow. An advantage of such an arrangement is that one or more stack segments whose aerofoil configurations are most suited to ambient fluid flow conditions can be brought into line with the fluid flow and the fluid flow optimised with regard to the performance of the turbine(s) rotor or rotors.

The tower may be rotatable by virtue of being mounted on a support post of the vertical axis turbine, or it may be mounted on an independent structure. For example, it can be mounted on a rotating base or slewing ring. Slewing rings are well known and are used in a wide variety of engineering applications.

Rotation of the tower is typically motor-driven. The motor may be operated manually, or it may be connected to an electronic controller which in turn is connected to a remote-control facility and/or sensors which sense the ambient fluid flow conditions. Thus, in one embodiment (Embodiment 57), the apparatus is automated so that it responds automatically to changes in ambient fluid flow conditions. In this embodiment, ambient fluid flow conditions are monitored and matched by the electronic controller (or a remote controller) to a particular set of aerofoil configurations. The tower is then rotated so that the region of aerofoils which most closely matches the optimal aerofoil configuration is brought into facing engagement with the fluid flow.

It will be appreciated that having a tower that can be rotated avoids the need for the individual aerofoils to be adjustable in response to changes in ambient conditions. The aerofoils can be fixed in particular configuration, thereby simplifying construction of the apparatus. However, there may be circumstances where fine-tuning of the aerofoil configurations is still of benefit and so a rotating tower may still comprise at least some aerofoils that are individually adjustable.

In one embodiment (Embodiment 58), therefore, the apparatus may comprise a mixture of fixed and adjustable aerofoils.

Rotating the tower also provides the ability to orient the entire structure and the rotors therein in a preferred orientation with regard to prevailing fluid direction and velocity. It has also been found that micro-adjustments of such an orientation can deliver significant performance benefits.

An aerofoil can be defined by reference to its chord length which is the length of a straight line between the leading edge and trailing edge of the aerofoil.

An aerofoil may be further characterised by its camber, which is a term indicative of the asymmetry between the upper and lower surfaces of an aerofoil and refers to the curve of the mean-line (geometric centre-line) of the aerofoil section.

By way of example, the aerofoils employed in the apparatus of the present invention may possess a chord length of approximately 0.5 m. However, it will be appreciated that the apparatus of the invention allows for the use of a range of chord lengths depending on the specific application.

A variety of aerofoil profiles may be employed and examples include aerofoil profiles described and defined in the NACA (National Advisory Committee for Aeronautics) classification system and variations thereof.

The aerofoil profiles, chord lengths, vertical spacings and angles of tilt of the aerofoils are selected so as to impart skew to a fluid flow such that the fluid flow is still skewed when it is incident upon the blades of the vertical-axis turbine whilst any reduction in fluid flow velocity is minimised.

By using CFD modelling, the variables of aerofoil profiles, vertical spacings, chord lengths and angles of tilt of the aerofoils can be optimised for the particular fluid flow velocities that might be encountered in a given location of use of the vertical axis turbine.

By way of example, it has been found by computational fluid dynamics (CFD) modelling of a stacked aerofoil array, where the aerofoils have a relatively shallow angle of tilt (e.g., approximately 20°), that if the vertical spacings are too large relative to the chord length at a given fluid flow velocity, the fluid flow is initially skewed but the fluid flow lines straighten out downstream of the aerofoils. Consequently, when the fluid comes into contact with the blades of the turbine, there is little or no remaining skew. This problem can be addressed, as shown in the Figures forming part of this application, by reducing the vertical spacings between the aerofoils until a required skew angle is maintained downstream of the aerofoils.

The required vertical spacings between the aerofoils will typically vary depending on the chord length of the aerofoil. By way of example, the ratio of the aerofoil's chord length to the vertical spacing between the aerofoils may be approximately 5:2. Therefore, with a chord length of 0.5 m, the recommended spacing would be 0.2 m. Similarly, if the chord length is 0.8 m, the vertical spacing would be around 0.32 m. The spacing is adjusted proportionally to maintain a consistent ratio between the chord length and the vertical spacing.

The aerofoils within the vertical array may be tilted to the same angle, as this can contribute to a more optimized system. While different angles within the provided ranges can be incorporated across part or all of the array, using the same angles may minimize walling effects and promote smoother and more controlled ducting. This approach helps achieve a better outcome in terms of overall performance and efficiency.

However, as stated above, in some embodiments, different regions of the array of aerofoils may be configured differently and optimized for different ambient fluid flow conditions.

In some embodiments of the invention, aerofoils (or aerofoil segments) towards an upper end of the support structure or tower may have a reduced chord length compared to the chord lengths of aerofoils or aerofoil segments lower down the support structure or tower.

For example, there may be one or more step reductions in chord length from bottom to top of the support structure or tower. By way of example, chord lengths may reduce from a length of 0.5 metres at the base of the support structure or tower to a chord length of 0.31 metres at the upper end of the support structure or tower.

Within a given region (e.g. stack segment) of the aerofoil array, there may be a reduction in chord length from bottom to top as set out above.

The angles of tilt of the aerofoils typically lie in the range from +40° to −40° to the horizontal, more usually in the range from +35° to −35°, for example from +30° to −30° to the horizontal.

As described below, iterative optimization has been carried out by utilizing Computational Fluid Dynamics (CFD) to refine and improve the design. The system is subject to significant variability in flow dependent upon fluid flow rate, density, and other dynamic factors. Optimal positioning of aerofoils for given, and in particular, highly variable conditions, has been achieved by trial and error as effective mathematical relationships between the various dynamic factors have not been apparent.

In general, the plurality of vertically spaced aerofoils will form a vertical stack at least 10 aerofoils high, typically at least 20 aerofoils high, and more usually at least 50 aerofoils high, although it will be appreciated that the precise number of aerofoils needed will depend to a large extent on the height of the vertical axis turbine(s). Thus, for example, depending on the height of the vertical axis turbine(s), the vertical stack of aerofoils may be from 10 to 200 aerofoils high, more usually from 20 to 100.

Accordingly, in further embodiments, the invention provides:

Embodiment 59: An apparatus or vertical axis turbine assembly according to any one of Embodiments 1 to 58 wherein the plurality of vertically spaced aerofoils forms a vertical stack at least 10 aerofoils high, typically at least 20 aerofoils high, and more usually at least 50 aerofoils high.

Embodiment 60: An apparatus or vertical axis turbine assembly according to Embodiment 59 wherein the vertical stack of aerofoils is from 10 to 200 aerofoils high, more usually from 20 to 100.

The aerofoils will have a radius (which term includes the equivalent dimension of centre to vertices in a polygon-shaped aerofoil or array of aerofoil segments) dependent on the size of the vertical axis turbine(s). By way of example, the aerofoil radius can vary between 1-7 m, depending on the specific design and requirements. This range allows for flexibility in tailoring the aerofoil size to different turbine configurations and operational needs.

### The Aerofoils May Have a Constant Radius From Top to Bottom of the Aerofoil Stack.

The radial gap between the aerofoils and the blades of the vertical axis turbine typically falls within the range of 0.16 m to 0.2 m, depending on the specific design and structure of the turbine.

The apparatus of the invention may be closed by a cap which has a domed or frustoconical profile, inclined surfaces of which serve to deflect air over the top of the tower and minimise turbulence. The cap may be provided in an upper surface thereof with indentations or recesses having profiles designed to direct fluid (e.g. air) flow passing over the top of the structure upward at an angle, into the blades of utility scale horizontal axis wind turbines (HAWTs) which may be located alongside the apparatuses of the invention. Initial studies have suggested a circa 3-7% increase in utility scale HAWT turbine performance due to co-location of HAWT and VAWT turbines in the same array.

### Accordingly, in Further Embodiments, the Invention Provides:

Embodiment 61: An apparatus or vertical axis turbine assembly according to any one of Embodiments 1 to 60 wherein the apparatus is closed by a cap which has a domed or frustoconical profile, inclined surfaces of which serve to deflect air over the top of the tower and minimise turbulence.

Embodiment 62: A combination of at least one vertical axis turbine assembly as defined in any one of the preceding Embodiments and at least one horizontal axis wind turbine.

Embodiment 63: A combination according to Embodiment 62 wherein the vertical axis turbine assembly is configured to direct air passing over the apparatus upwards at an angle into the blades of the horizontal axis turbine.

Further embodiments and aspects of the invention will be apparent from the description of the specific apparatus set out below.

### BRIEF DESCRIPTION OF THE DRAWINGS

FIG. 1 shows a Computational fluid dynamics (CFD) rendering based on a NACA 18 profile aerofoil having a 0.5 metre chord, where all aerofoils are angled downwardly (from leading edge to trailing edge) at 20 degrees from the horizontal, the aerofoil vertical spacings are 0.5 metres, and the wind speed is 7.8 metres per second.

FIGS. 2 and 3 are closer views of the rendering shown in FIG. 1.

FIG. 4 shows a Computational fluid dynamics (CFD) rendering based on a NACA 18 profile aerofoil as shown in FIG. 1, where all aerofoils are angled at 20 degrees from the horizontal, and the wind speed is 7.8 metres per second, but wherein the aerofoil vertical spacings are 0.2 metres rather than the 0.5 metres spacings used in FIG. 1.

FIGS. 5 to 9 Show Further Views of the 0.2 Metre Stack of FIG. 4.

FIG. 10 is a schematic side view of an apparatus comprising a plurality of vertically spaced aerofoils in accordance with one embodiment of the invention. In this embodiment, the aerofoils are at an angle of +25 degrees from horizontal. In this Figure and FIGS. 11 to 15, details of the support structure shown in the Figures have been minimised. Thus, for example, structural elements linking the aerofoils to the support structure and control elements such as cables and control rods have not been shown.

FIG. 11 is a perspective view of the apparatus of FIG. 10.

FIG. 12 is an enlarged perspective view of an upper part of the apparatus of FIGS. 10 and 11.

FIG. 13 is an enlarged side view of an upper part of the apparatus of FIGS. 10 and 11.

FIG. 14 is an enlarged side view corresponding to FIG. 13 but showing the aerofoils titled at an angle of −25 degrees from horizontal.

FIG. 15 is a further enlarged perspective view of part of the apparatus configured as shown in FIG. 14.

FIG. 16 is a view from one side of an apparatus comprising a plurality of vertically spaced aerofoils in accordance with a second embodiment of the invention.

FIG. 17 is a view from the opposite side of the apparatus of FIG. 16.

FIG. 18 is a longitudinal sectional view of the apparatus of FIGS. 16 and 17.

FIG. 19 is a view from above of the apparatus.

FIG. 20 is a front view of an apparatus according to another embodiment of the invention.

FIG. 21 is a rear view of the embodiment of FIG. 20.

FIG. 22 is a side view of the apparatus of FIGS. 20 and 21.

FIG. 23 is a plan view of the apparatus of FIGS. 20 to 22.

FIG. 24 is a schematic perspective view of one type of Darrieus vertical axis wind turbine for use in accordance with the present invention. In this embodiment, the turbine has an H-rotor configuration.

FIG. 25 is a schematic perspective view of another type of Darrieus vertical axis wind turbine for use in accordance with the present invention.

FIG. 26 is a schematic perspective view of another type of Darrieus vertical axis wind turbine for use in accordance with the present invention. In this embodiment, the turbine has a helical configuration.

FIG. 27 is a schematic view from above of another type of Darrieus vertical axis wind turbine for use in accordance with the present invention. In this embodiment, the turbine has a variable pitch or cyclorotor configuration.

### DETAILED DESCRIPTION OF PARTICULAR EMBODIMENTS OF THE INVENTION

The invention will now be illustrated by way of non-limiting examples by reference to the specific embodiments described in the accompanying Figures.

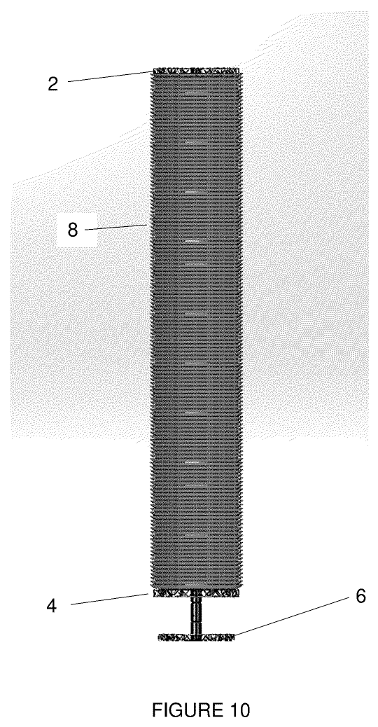

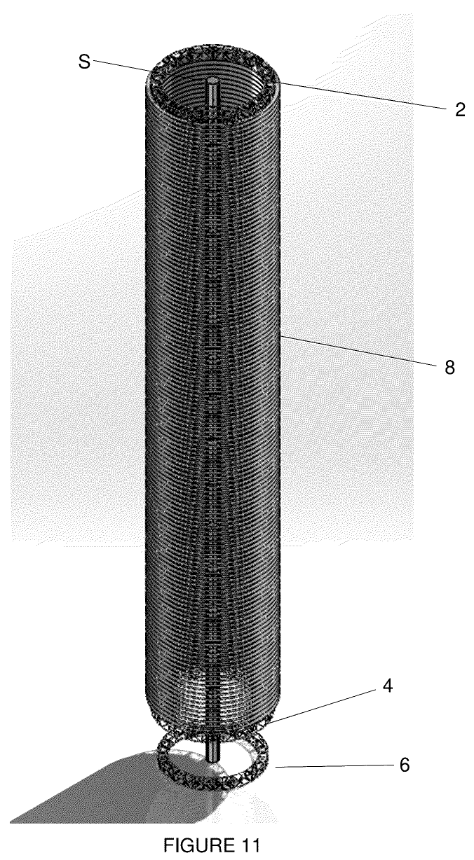

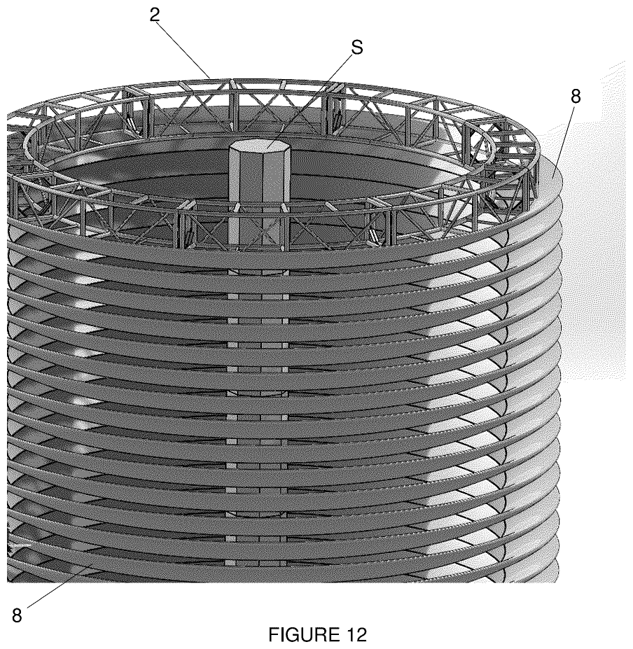

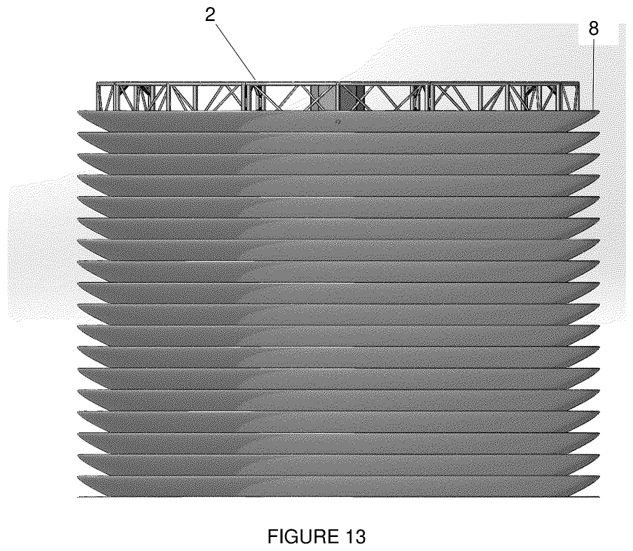

An apparatus according to one embodiment of the invention is illustrated in FIGS. 10 to 13. The apparatus comprises a support frame, representative parts of which are shown as elements (2), (4) and (6), upon which are mounted a plurality of aerofoils (8).

The apparatus shown in FIGS. 10 to 13 can be provided in either a fixed aerofoil or tiltable aerofoil form. Where the aerofoils are at a fixed angle, they are secured to the support structures (2), (4) and (6) by means of support elements, not shown.

Where the aerofoils are variable in angle, they are typically connected to control rods or cables which in turn are connected to a control mechanism for moving the cables and control rods to bring about tilting of the aerofoils. The control mechanism in turn is connected to an electronic controller which can respond to manual inputs and/or to inputs from sensors such as wind speed and wind direction sensors to change the angle of the aerofoils and optionally also the vertical spacings between the aerofoils.

The control rods, cables, control mechanism, electronic controller and sensors are not shown in the Figures.

In FIGS. 10 to 13, the aerofoils are angled at +25° from horizontal, i.e. the leading edges of the aerofoils are tilted upwards at an angle of +25° from horizontal.

The aerofoils in this embodiment of the invention are formed from a framework of tubes covered with a tightly stretched skin formed from a suitably tough, durable and weather resistant fabric.

Alternatively, they may be formed by moulding or extruding a suitably tough, and preferably lightweight plastics or metal materials such as aluminium.

The aerofoils are shown as being circular in plan. When the aerofoils are intended to be tiltable, they need to be sufficiently flexible to ensure that they do not buckle or distort when tilted. This can be achieved by using telescoping tubes for the framework of the aerofoil so that the leading and trailing edges of the aerofoils can expand or contract in a circumferential direction as needed when the aerofoils are tilted. The telescoping tubes can be connected by springs or other resilient elements so that they are resiliently biased towards each other and can absorb any distortions of the aerofoil shape as it is tilted and then restore the aerofoil to a normal shape after tilting.

As an alternative to the aerofoils being circular in plan, each aerofoil can comprise a plurality of part circular aerofoil segments with lateral (circumferential) spaces between them. This arrangement will reduce aerofoil buckling during tilting. Each of the part circular aerofoil segments may be formed from a tubular framework covered in a fabric skin and, as with the full circular aerofoils, the framework may comprise telescoping tubes and resilient biasing elements such as springs to absorb any distortions during tilting.

Also shown in the Figures is the support post(S) for the vertical axis turbine. The turbine itself has been omitted for clarity.

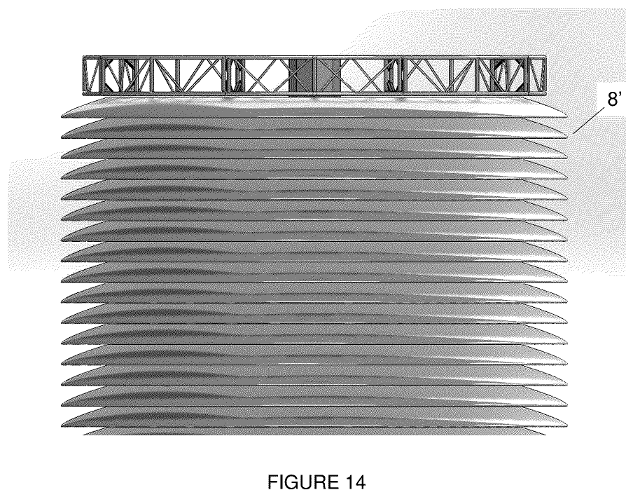

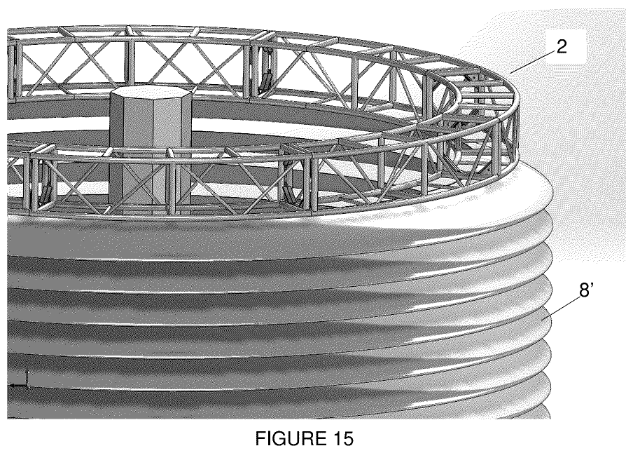

An apparatus according to a second embodiment of the invention is shown in FIGS. 14 and 15. The construction of the apparatus is identical or analogous to the construction shown in FIGS. 10 to 13 except that the aerofoils are tilted at an angle of −25° from horizontal, i.e., the leading edges of the aerofoil are tilted downwards by an angle of −25° from horizontal. As with the embodiment shown in FIGS. 10 to 13, the apparatus of FIGS. 14 and 15 can be provided in either a fixed angle variant or a variable angle variant subject to the inclusion of the necessary control rods or cables. The embodiment shown in FIGS. 14 and 15 may also be provided in a variant in which each aerofoil comprises a plurality of part circular aerofoil segments.

The aerofoils shown in the apparatuses of FIGS. 10 to 15 can be selected from the profiles defined in the NACA (National Advisory Committee for Aeronautics) classification system and variations thereof. One particular profile that has been used and tested is the NACA 18 profile.

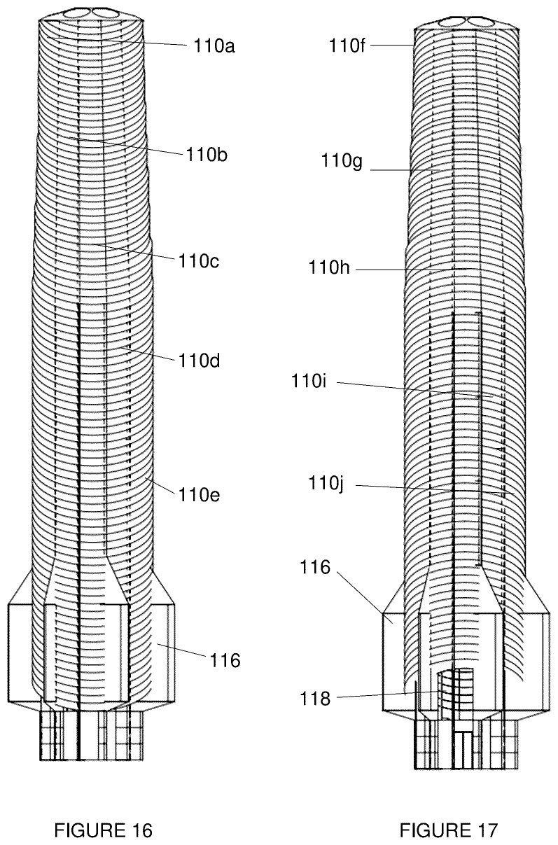

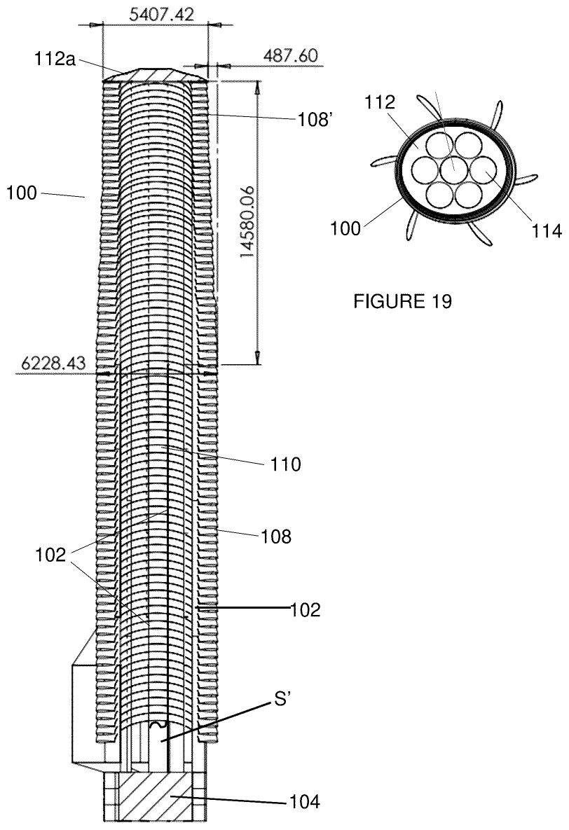

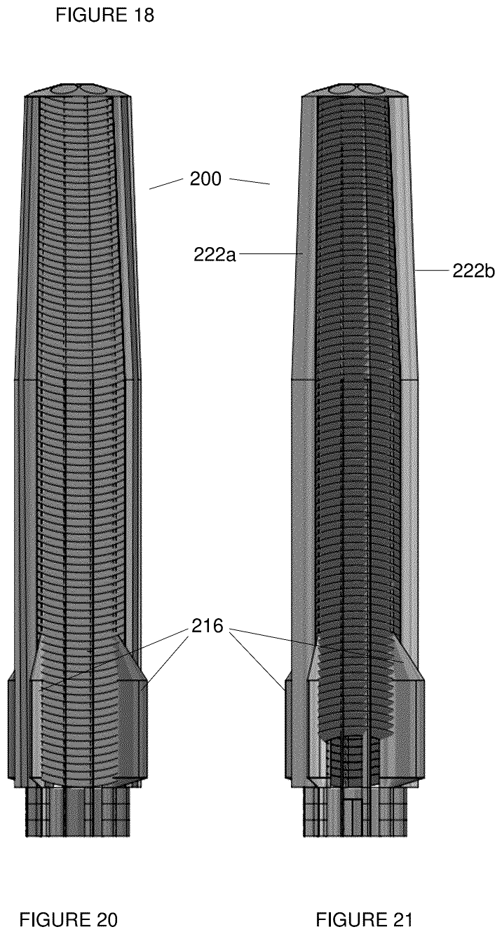

An apparatus according to a second embodiment of the invention is shown in FIGS. 16 to 18. The apparatus is in the form of a tower (100) comprising a plurality (in this particular case ten) of upwardly extending frame members (102) arranged in a generally circular pattern and mounted at their lower ends on a base (104) which is firmly anchored in the underlying ground. A support post S′ for a vertical axis wind turbine is also set into the base (104). Only the stub of the support post (S′) is shown in FIG. 18. The remainder of the support post and the wind turbine mounted on it have been omitted for clarity.

An array of stacked annular rows of fixed aerofoils (108, 108′) is mounted on the frame members (102). Each annular row of aerofoils comprises a plurality (ten in the particular embodiment shown in FIGS. 16 to 18) of arcuate aerofoil segments, the two ends of each aerofoil segment being fixed to the frame members (102). Although the drawings illustrate rows of aerofoils consisting of ten aerofoil segments, it will be appreciated that a row may be formed from fewer or more segments, and the number of frame members (102) adjusted accordingly.

The aerofoils can have the profiles described above in relation to the first embodiment of the invention.

The aerofoil segments (108, 108′) are typically formed from recyclable and/or recycled polymers produced via additive manufacturing (3D printing) and the frame members (102) are formed from a suitable steel which is either corrosion resistant or is coated with a anti-corrosion protecting material. Engineering polymers may also be employed for all or part of the frame members (102)

The aerofoils making up the array may all have the same configuration and may all be mounted on their respective frame members at the same angle. More usually, however, aerofoils of several different profiles may be used and may be mounted in groups at different angles on their support frames in order to accommodate different wind conditions.

For example, as shown in FIG. 19, the aerofoils (108′) at the upper end of the stack may have a shorter chord length than the aerofoils (108) lower down the stack. There may be a small number (e.g. one, two or three) of step reductions in chord length between different regions at different heights in the stack, or there may be a more continuous reduction (i.e. larger number of smaller step reductions) in chord length towards the top of the stack.

The variations in chord lengths of the aerofoils are selected so as to optimise the performance of the array in the light of the prevailing wind conditions.

In a similar manner, the angles of the aerofoils may be varied along the length (height) of the stack to provide optimal performance.

The tower of aerofoils can be viewed as a plurality of substantially vertically oriented stack segments (110), each stack segment comprising a plurality of stacked arcuate aerofoil segments, the two ends of each of the arcuate aerofoil segments being attached to the same two adjacent frame members. In the apparatus shown in FIGS. 16 to 19, there are ten such stack segments. Stack segments (110a), (110b), (110c), (110d) and (110e) are shown in FIG. 16 whereas stack segments (110f), (110g), (110h), (110i) and (110j) are shown in FIG. 17.

A stack segment may have the same combination of aerofoil configurations and aerofoil angles as one or more other stack segments, or each stack segment may have a set of aerofoil configurations and aerofoil angles which differs from all the other stack segments. For example, in the apparatus illustrated, a group of four contiguous stack segments (e.g. stack segments (110a), (110b), (110c), (110d)) may have one common set of aerofoil configurations and aerofoil angles, and two other groups (e.g. the group (110e), (110f), (110g) and the group (110h), (110i), (110j)) of three stack segments may share different common sets of aerofoil configurations and aerofoil angles.

Each stack segment or group of stack segments may be configured to provide optimal performance for a given set of wind conditions. For example, the group consisting of the four stack segments (110a), (110b), (110c) and (110d) may have a set of aerofoil configurations and aerofoil angles optimised for the normally prevailing wind conditions (e.g. wind direction and wind speed), whereas the two groups of three stack segments may have sets of aerofoil configurations and aerofoil angles optimised for different wind conditions. In order to enable the most appropriate group of stack segments to be presented to the wind, the tower is rotatable about a substantially vertical axis so that a stack segment or group of stack segments optimised as far as possible for the prevailing wind conditions can be arranged to face the wind.

The mechanism for rotation of the tower has been omitted for clarity from the drawings but could take various forms. For example, the tower may be rotatably mounted on the support post (S′) of the wind turbine. More usually, however, the tower is mounted on a slewing ring of a standard commercially available type.

The tower is typically held against free rotation, but can be rotated to present a desired stack segment or group of stack segments to the wind by means of a motorised drive mechanism (not shown). Instruments for sensing wind direction and wind speed are typically linked to the motorised drive via an electronic controller so that the tower can be rotated automatically in response to changes in wind conditions. Alternatively, the motorised drive can be operated manually.

The top of the tower (100) is closed by a cap (112) which has a domed or frustoconical profile, the inclined surfaces (112a) serving to deflect air over the top of the tower and minimise turbulence. Set into the upper surface of the cap are indentations or recesses (114), which behave in a similar manner to the dimples in golf balls. The indentations or recesses (104) have profiles designed to direct fluid (e.g. air) flow passing over the top of the structure upward at an angle, into the blades of utility scale horizontal axis wind turbines (HAWTs) which may be located alongside the apparatuses of the invention. Initial studies have suggested a circa 3-7% increase in utility scale HAWT turbine performance due to co-location of HAWT and VAWT turbines in the same array.

At the base of the tower (100) and extending outwardly therefrom are vanes (116). In the embodiment shown in the Figures, there are six vanes (116), although there could be more or fewer if desired. The vanes (116) are generally aerofoil-shaped and lie in a substantially vertical plane. The geometric mean lines of the vanes are typically at an angle of from 50° 70° with respect to the tangent of the circular surface of the tower. The purpose of the vanes (116) is to modify fluid flow at the base of the tower.

It is known that fluid velocity tends to be significantly less, and characteristics close to the ground tend to be more turbulent, than fluid found at higher altitudes. At the lower levels the vanes (116) are therefore employed to in effect ‘scoop and stabilise’ fluid. In this way, both more fluid is captured and funnelled meaningfully into the tower, but also a more laminar flow can also be introduced in such a manner.

The extended vanes also serve to prevent fluid bleed; in that on a circular or tube-like structure, fluid will direct itself around the periphery of the structure with sufficient volume and velocity so as to draw fluid behind it and create a current that is detrimental to turbine performance; although it can be directed to enhance the performance of other separate but nearby towers. Where the desire is to direct as much useful fluid into the turbine as possible, the extended vanes (116), which can extend to up to or beyond the diameter of the entire tower on either side, can be employed to scoop and stabilise fluid.

When combined with slewing, it has been found that employing vanes to face into the oncoming fluid operates as a form of extended duct, whilst closing the aerofoils entirely to either side of the tower, yet leaving the aerofoils open to the rear to exit via a further set of vanes, produces an extremely desirable effect. In this way, the tower acts as a form of wind tunnel, and also allows for further direction of fluid within the tower.

Extended vanes may also be added at differing points further up the tower, dependent upon prevailing fluid conditions.

At the base of the tower is provided a service door (118) which allows access to the interior of the tower and the wind turbine therein and may optionally be closed by lockable doors for security.

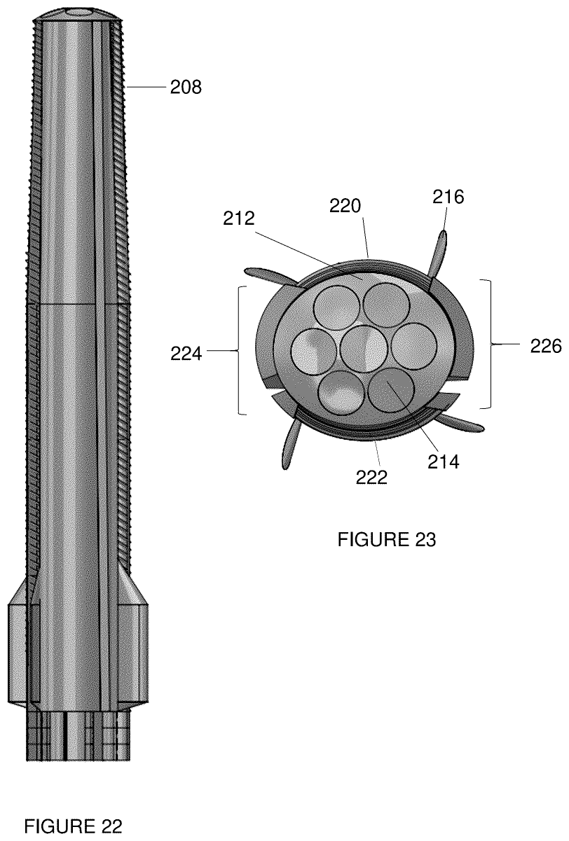

In the embodiments shown in FIGS. 10 to 19, the aerofoil arrays extend around the entire circumference of the apparatus. However, in an alternative embodiment, a slewing tower with extended vanes has aerofoils to the front and rear of the tower but no externally facing aerofoils to either side. Instead of arrays of aerofoils, the sides are closed by wall panels. Such an embodiment is illustrated in FIGS. 20 to 23.

Thus, the apparatus of FIGS. 20 to 23 has a similar structural framework to the apparatus of FIGS. 16 to 19 but, instead of having stacks of aerofoils (208) completely surrounding the vertical axis turbine, has two opposed arrays of aerofoils (220, 222) each extending from top to bottom of the tower, and two regions (224, 226) located horizontally between the arrays of aerofoils, where there are no externally facing aerofoils. The two regions (224, 226) can be formed from curved panels moulded from a suitably tough plastics material or composite. The interior surfaces of the curved panels may be provided with aerofoils of other fluid-guiding elements to further shape and direct fluid flow within the tower.

At the foot of the tower are mounted four vanes (216) each having an aerofoil profile in cross section. The vanes (216) are located at the boundaries between the arrays of aerofoils (220, 222) and the two regions (224, 226) and serve to deflect fluid flow in the direction of the aerofoils.

As with the apparatus of FIGS. 16 to 19, the top of the tower (200) is closed by a cap (212) which has a domed or frustoconical profile, and a plurality of indentations or recesses (214), which function as described above in relation to the apparatus of FIGS. 16 to 19.

Fluid (e.g. air) passes between the aerofoils in the “front” array (220), past the vertical axis turbine inside the tower and out between the aerofoils of the “rear” array (222). At or near ground level, where fluid speeds are lower and/or more turbulent, the vanes (216) help to overcome the effects of the ground surface on the fluid flow and channel the fluid into the aerofoil array (220). As the sides of the tower as closed by the panels in regions (224, 226), the interior of the tower shown in FIGS. 20 to 23 functions as a wind tunnel.

It will be appreciated from the foregoing that the apparatuses of the invention can be configured in one of several main ways.

In one general embodiment, the tower or array of aerofoils does not rotate and the individual aerofoils have a fixed angle and do not rotate. In this embodiment the configurations of the aerofoils and the aerofoil angles are fixed and are selected so as to be optimal for the prevailing wind conditions.

In another general embodiment, the tower or array of aerofoils does not rotate but the individual spacings between aerofoils and the angles of the aerofoils can be adjusted to suit the wind conditions.

In a further embodiment, the tower can rotate to bring a desired set of aerofoils into the wind. In this embodiment, because the tower can rotate, it is not necessary for the individual aerofoils to be adjustable in angle and spacing.

In a still further embodiment, the tower can rotate and the individual aerofoils can be adjustable.

In a still further embodiment, the tower can rotate and is provided with opposed regions bearing aerofoils and, interposed therebetween, opposed regions with smooth outer surfaces and which have no externally facing aerofoils.

The embodiments shown in FIGS. 10 to 23 typically accommodate a single vertical axis turbine. However, by constructing the apparatuses of a sufficient size (e.g. diameter), more than one vertical axis turbine can be accommodated. In one embodiment, seven separate turbines are accommodated within the apparatus and run the full height of the structure, each revolving around a separate vertical axis.

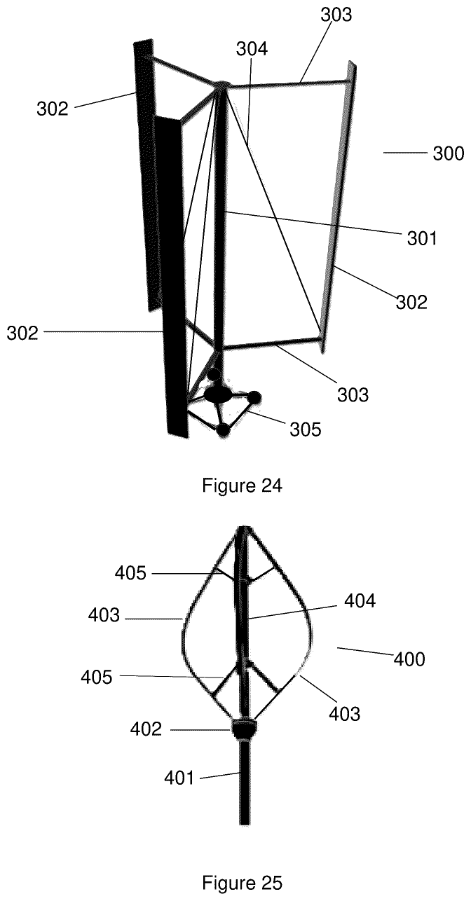

Examples of types of vertical axis wind turbines that can be used together with, or as part of, the apparatuses of the invention, are shown in FIGS. 24 to 27.

FIG. 24 is a schematic perspective view of a Darrieus-type vertical axis wind turbine having an H-rotor configuration. The turbine (300) comprises a base structure (305) upon which is mounted a rotating shaft (301). Secured to the rotating shaft (301) by upper and lower pairs of supporting arms (303) and diagonal reinforcing struts (304) are three elongate turbine blades (302) which are generally parallel to the rotating shaft (301). When exposed to wind from a direction transverse (e.g. perpendicular) to the rotational axis of the shaft (301), the flow of air over the blades (302) causes the shaft (301) to rotate. The rotational movement is converted into electrical energy either by means of a generator set into the hub in the base structure (305) or a generator connected by a mechanical linkage (not shown) to the shaft (301).

FIG. 25 is a schematic perspective view of another variant of a Darrieus vertical axis wind turbine for use in accordance with the present invention. The turbine (400) comprises a support shaft (401) upon which is mounted a hub (402). A rotating shaft (404) extends upwardly from the hub (402). Attached to the top of the shaft (404) and to a rotating element within the hub (402) are elongate curved rotor blades (403). Diagonal struts (405) provide reinforcement to the structure. When exposed to wind, air flow in a transverse direction relative to the axis of rotation of the shaft (404) over the blades (403) causes the turbine to rotate. The rotational movement can be converted into electrical energy either through a generator set into the hub (402) or by a generator linked by a mechanical element (e.g. rotating shaft) passing through the support shaft (401).

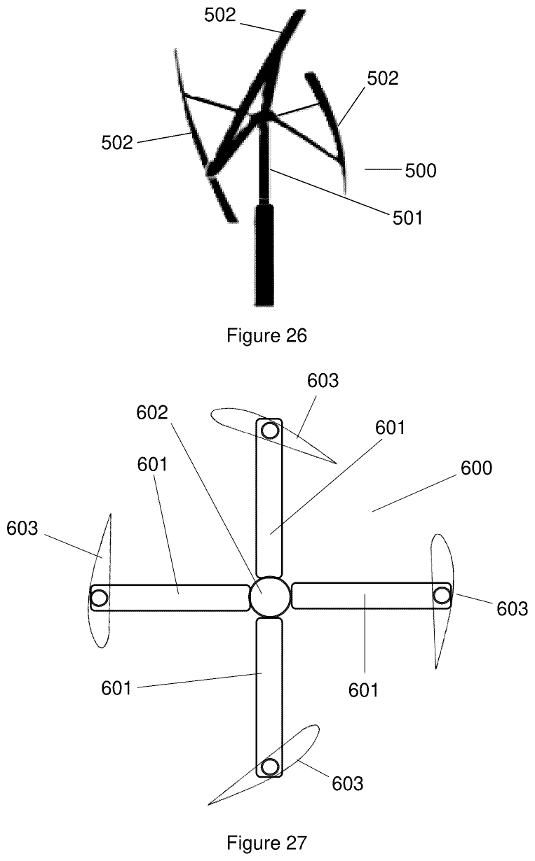

FIG. 26 is a schematic perspective view of a Darrieus vertical axis wind turbine (500) wherein the turbine blades (502) are arranged in a helical configuration about a rotating shaft (501).

FIG. 27 is a schematic view from above of a Darrieus vertical axis wind turbine having a variable pitch or cyclorotor configuration. The turbine (600) comprises four pairs of upper (601) and lower radial arms (lower arms not shown) extending outwardly from a vertically oriented rotating shaft (602). The rotating shaft (602) is mounted in a suitable support structure (not shown) and the rotational output from the shaft is used either directly, or indirectly through a mechanical linkage, to drive an electricity generator. Mounted vertically between each pair of radial arms (601) is a turbine blade (603) having an aerofoil profile.

The turbine blades are pivotably mounted on the radial arms so that the angle (pitch) of the turbine blades can be changed in order to optimise the performance of the turbine (see for example Benmoussa et al., “Enhancement of a cycloidal self-pitch vertical axis wind turbine performance through DBD plasma actuators at low tip speed ratio”, International Journal of Thermofluids, 29 Nov. 2022, and Lazauskas, Leo (January 1992). “Three pitch control systems for vertical axis wind turbines compared”. Wind Engineering. 16 (5): 269-282.

### EXAMPLES

Computational fluid dynamics (CFD) modelling was carried out on several aerofoil configurations to show the effect of aerofoil size, spacing and angle on fluid flow.

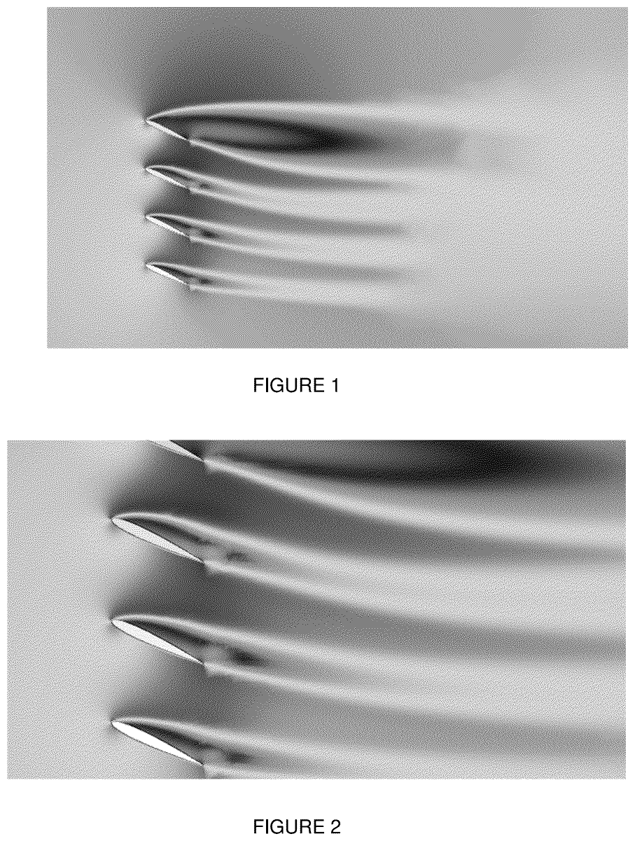

FIG. 1 is a CFD rendering showing wind flow through a vertical array of aerofoils having a 0.5 metre chord on a NACA 18 profile, with all aerofoils being angled at +20°°and aerofoil spacing of 0.5 metres, with a wind speed of 7.8 metres per second.

FIG. 1 shows that the spacing of the aerofoils is ineffective, and the wind direction can be seen to be relatively unaffected and without skew.

The figures show fluid velocity, where red is rapidly moving air, and blue is slow-moving air. Note in particular the way in which the low velocity area to the top of the aerofoil stacked array is held level by the fluid moving horizontally below after passing through the aerofoils. Velocity is increased in narrow bands, but skew is not maintained downstream of the aerofoil. Instead, the wind flow lines return to a substantially horizontal orientation.

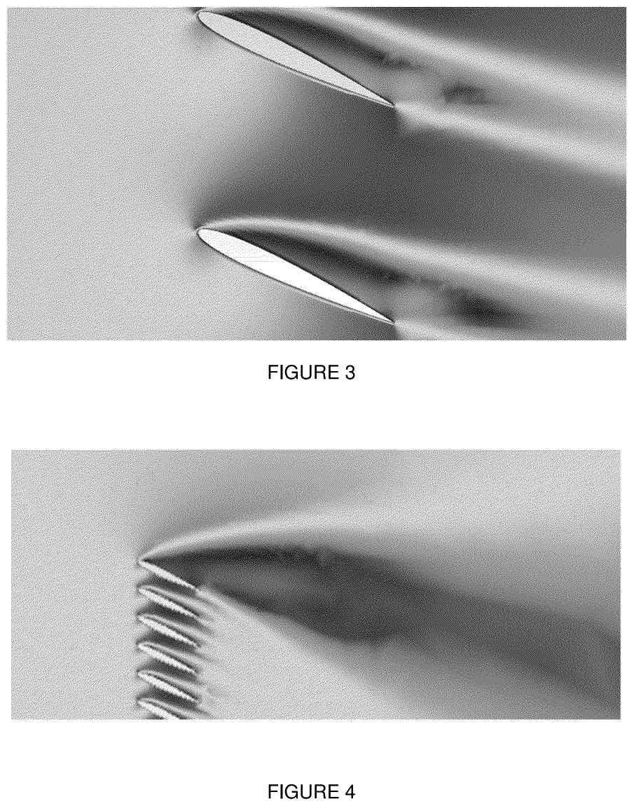

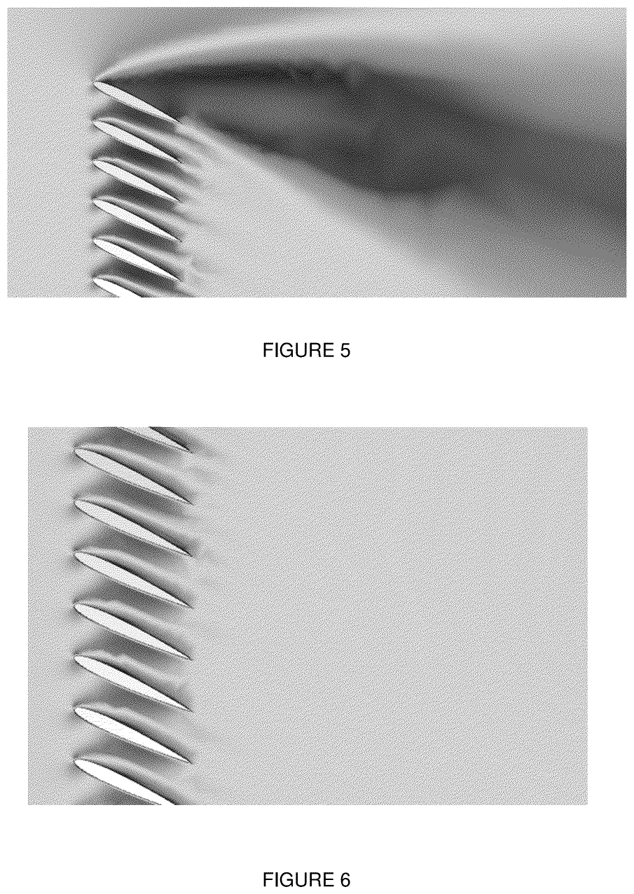

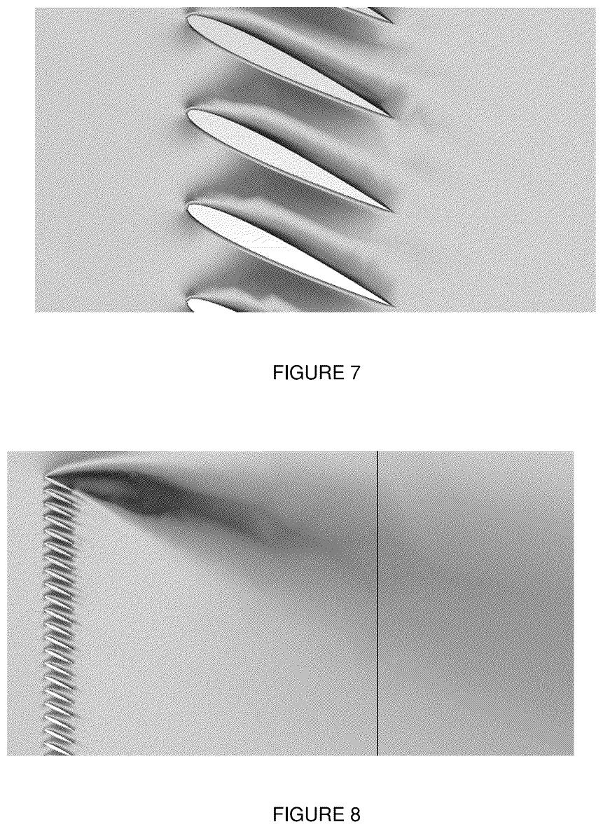

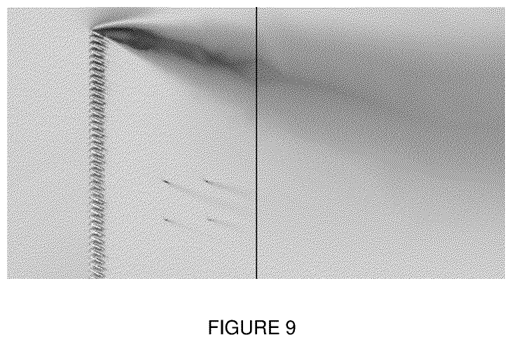

FIGS. 2 and 3 are closer views of the velocity pattern and further demonstrate the absence of skewed flow.

FIG. 4 is a CFD rendering of an alternative set up wherein the same aerofoils and the same wind speed were used as in the CFD renderings in FIGS. 1 to 3, but the vertical spacings of the aerofoils was reduced from 0.5 metres to 0.2 metres. This resulted in the wind being redirected at a 20° angle with a minimum loss of velocity. Note that the wind speed both before and after the aerofoil stack is the same colour, denoting the same or very similar velocity. Note, however, the manner in which the low velocity blue area is now pulled downward by the skewed flow, illustrating the effect of the aerofoil spacing. Slightly increased velocity lines can also be observed emanating from the aerofoil array, but on this occasion at the appropriately skewed angle. Thus, in the arrangement with the 0.2 metre vertical spacing, the skew angle imparted to the air flow as it passes between the aerofoils is maintained downstream of the aerofoils, and hence a skewed air flow can then be directed onto the blades of a vertical axis wind turbine downstream of the aerofoils, with a consequent improvement in the performance of the turbine.

Using the template described above, the skilled person will readily be able to determine the configurations and spacings for other aerofoil profiles and wind speeds.

### Equivalents

The examples described above and shown in the accompanying drawings are intended to illustrate the invention and not to limit it in any way. It will readily be apparent to the skilled person that numerous modifications and alterations could be made to the specific embodiments illustrated without departing from the principles underlying the invention and all such modifications and alterations are intended to be embraced by the claims appended hereto.

1. An apparatus for introducing skew to a fluid flow directed on to one or more vertical axis turbines, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow between the aerofoils is skewed before it is incident upon the one or more vertical axis turbines.

2. An apparatus for introducing skew to a fluid flow directed on to one or more vertical axis turbines, said vertical axis turbine being one which is driven by fluid flow onto the turbine from a predominantly transverse direction relative to the axis of rotation of the turbine, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow between the aerofoils is skewed at a skew angle of up to +30°, for example from +10° to +30° or −10° to −30° (e.g. a skew angle in the range from +25° to +29°; or a skew angle in the range from −25° to −29°), before it is incident upon the one or more vertical axis turbines

3. An apparatus for introducing skew to a fluid flow directed on to one or more vertical axis turbine, said vertical axis turbine being one which is driven by fluid flow onto the turbine from a predominantly transverse direction relative to the axis of rotation of the turbine, the apparatus comprising a support structure having mounted thereon a plurality of vertically spaced aerofoils arranged to partially or completely surround the one or more vertical axis turbines, the vertical spacings being selected and the aerofoils being profiled and arranged at an angle such that fluid flow is skewed at a skew angle of up to ±30°, for example from +10° to +30° or −10° to −30° (e.g. a skew angle in the range from +25° to +29°; or a skew angle in the range from −25° to −29°), as it flows between the aerofoils and remains skewed as it is incident upon the one or more vertical axis turbines.

4. An apparatus according to claim 3 for introducing skew to a fluid flow directed on to one or more vertical axis turbines, the apparatus comprising a support structure having mounted thereon a plurality of vertically spaced aerofoils arranged to surround the one or more vertical axis turbines, the vertical spacings being selected and the aerofoils being profiled and arranged at an angle such that fluid flow is skewed as it flows between the aerofoils and remains skewed as it is incident upon the one or more vertical axis turbines.

5. An apparatus according to claim 1 wherein the support structure is rotatable about a substantially vertical axis.

6. An apparatus according to claims 1 wherein two or more outwardly extending vanes are provided at or near a lower end of the support structure.

7. An apparatus according to claims 1 which is configured for use with one or more wind turbines.

8. An apparatus according to claim 7 which is configured for use with one or more wind turbines having a Darrieus or Savonius configuration, for example with one or more variable-pitch vertical-axis wind turbines. cm 9. An apparatus according to claim 1 wherein the aerofoils are static, i.e. they have a fixed angle and vertical spacing.

10. An apparatus according to claim 1 wherein the aerofoils are adjustable in angle and/or vertical spacings.

11. An apparatus according to claim 1 wherein the plurality of vertically spaced aerofoils forms a vertical stack which is:
(a) at least 10 aerofoils high;
(b) at least 20 aerofoils high;
(c) at least 50 aerofoils high;
(d) from 10 to 200 aerofoils high; or (e) from 20 to 100 aerofoils high.

12. A vertical axis turbine assembly comprising one or more vertical axis turbines and an apparatus for introducing skew to a fluid flow as defined in claim 1.

13. A vertical axis turbine assembly according to claim 12 having a Darrieus or Savonius configuration, for example a variable-pitch vertical-axis wind turbine.

14. A method of increasing the efficiency of a vertical axis turbine, which method comprises surrounding the vertical axis turbine with a support structure having mounted thereon a plurality of vertically spaced aerofoils as defined in claim 1, the vertical spacings being selected and the aerofoils being profiled and arranged at an angle such that fluid flow between the aerofoils is skewed before it is incident upon the vertical axis turbine.

15. A combination of at least one vertical axis assembly as defined in claim 12 and at least one horizontal axis wind turbine.

16. (canceled)
